(19) United States
(12) Patent Application Publication
(10) Pub. No.: US 2017/0086481 A1
(43) Pub. Date: Mar. 30, 2017

(54) NUTRITIONAL COMPOSITIONS COMPRISING A LIPOPHILIC ACTIVE INGREDIENT

(71) Applicant: ABBOTT LABORATORIES, Abbott Park, IL (US)

(72) Inventors: PAUL JOHNS, Columbus, OH (US); MUSTAFA VURMA, Dublin, OH (US); STEPHEN DEMICHELE, Dublin, OH (US); GARY KATZ, Columbus, OH (US)

(73) Assignee: ABBOTT LABORATORIES, Abbott Park, IL (US)

(21) Appl. No.: 15/315,987

(22) PCT Filed: Jun. 3, 2015
(86) PCT No.: PCT/US2015/033928

§ 371 Date: Dec. 2, 2016

Related U.S. Application Data
(60) Provisional application No. 62/007,037, filed on Jun. 3, 2014.

(51) Int. Cl. A23L 2/52; A23L 33/15; A23L 33/19

(52) U.S. Cl. CPC A23L 2/52; A23L 33/19; A23L 33/15; A23V 2002/00

(57) ABSTRACT

Disclosed embodiments provide methods and compositions for improving the metabolic health of consumers. Bovine beta-casein, a major component of milk from cattle, has many genetic variants. Certain genetic variants, A1 in particular, have been associated with type 1 diabetes. The disclosed methods and compositions include reduced amounts of genetic variants of beta-casein that have been associated with diabetes. In some embodiments, the compositions display improved emulsions due to the solubility and hydrophobicity of the genetic variants of beta-casein used therein.

### CROSS-REFERENCE TO RELATED APPLICATIONS

This application claims priority to and any benefit of U.S. Provisional Application No. 62/007,037, filed Jun. 3, 2014, the content of which is incorporated herein by reference in its entirety.

### TECHNICAL FIELD

Disclosed embodiments are in the field of nutritional compositions and more particularly in the field of nutritional compositions comprising milk proteins including bovine beta-casein genetic variant A2 in conjunction with a lipophilic active ingredient.

### BACKGROUND

Adult, pediatric, and infant manufactured nutritional compositions often comprise one or more lipophilic nutrients. When the compositions are ingested, the lipophilic nutrients often are less bioavailable than desired. As a result, the nutritional compositions often are over-fortified with lipophilic nutrients to ensure that the desired nutritional benefits from the nutrients are obtained. In some cases, the over-fortification can be from about 2 times to about 10 times the amount required to achieve the desired benefits. These high fortification rates increase the production costs without providing additional consumer benefits.

In addition, proteins sourced from cow's milk are utilized in many nutritional compositions. Much of the milk-sourced proteins used in the United States comes from cows of the breed Holstein-Friesian, with whey and casein proteins making up the vast majority of the protein obtained from cow's milk. While milk from different cattle breeds often has very similar profiles, not all casein proteins contained within the milk are identical. For example, beta-casein is generally recognized as having 12 genetic variants: A1, A2, A3, B, C, D, E, F, G, H1, H2, and I. Milk proteins from differing cattle breeds often possess different beta-casein genetic profiles. In particular, the cattle breed Holstein-Friesian has been identified as a breed that produces milk high in beta-casein genetic variant A1, whereas both the Guernsey and Zebu breeds produce milk in which A2 is the predominant genetic variant.

### SUMMARY

Provided herein are nutritional compositions displaying improved bioavailability of lipophilic nutrients as well as methods for preparing nutritional compositions exhibiting such improved bioavailability. These nutritional compositions comprise protein sourced from cow's milk. Certain genetic variants have been shown to possess differing physiochemical properties. For example, as discussed herein, beta-casein genetic variant A2 (A2 beta-casein) is relatively more hydrophobic and displays enhanced emulsifying properties relative to genetic variant A1. While not wishing to be bound by theory, it is believed that this difference in hydrophobicity facilitates enhanced delivery of certain lipophilic nutrients when a portion of the Al beta-casein utilized in nutritional compositions is replaced with A2 beta-casein. In addition, certain exemplary embodiments comprise monoglyceride and diglyceride oil (MDG oil), and in certain exemplary embodiments, a premix comprising MDG oil.

In a first exemplary embodiment, a shelf stable nutritional composition is provided. The nutritional composition comprises protein including about 10 to about 100 wt % bovine beta-casein. The bovine beta-casein comprises about 50% to about 100% genetic variant A2. The nutritional composition also includes a lipophilic nutrient. The molar ratio of the A2 bovine beta-casein to the lipophilic nutrient is about 10:1 to about 10,000:1.

In a second exemplary embodiment, a shelf stable liquid nutritional composition comprising fat, carbohydrate, protein, monoglyceride and diglyceride oil, and a lipophilic nutrient is provided. The lipophilic nutrient is selected from vitamin A, vitamin D, and vitamin E. The protein comprises about 10% to about 100 wt % of bovine beta-casein, and the beta-casein comprises about 50% and about 100% A2 beta-casein. The molar ratio of the A2 beta-casein to the lipophilic nutrient is from about 10:1 to about 10,000:1.

In a third exemplary embodiment, a liquid nutritional composition with improved lipophilic nutrient stability is provided. The nutritional composition comprises carbohydrate, protein, fat, and a lipophilic nutrient. The protein comprises about 10% to about 100 wt % bovine beta-casein, wherein the bovine beta-casein is about 50% to about 100% genetic variant A2. The composition further comprises a premix comprising monoglyceride and diglyceride oil. The nutritional composition is formed by adding the premix to an aqueous solution to form an activated premix, and adding the activated premix to the nutritional composition.

In a fourth exemplary embodiment, a method for preparing a nutritional composition comprising a lipophilic nutrient having improved bioavailability is provided. The nutritional composition comprises bovine beta-casein in an amount of about 10% to about 100% by weight of the total protein, the bovine beta-casein comprising about 50% to about 100% genetic variant A2. The method comprises providing a premix comprising monoglycerides, diglycerides, and a lipophilic nutrient, adding the premix to an aqueous solution to form an activated premix, and adding the activated premix to the nutritional composition.

### DETAILED DESCRIPTION

Provided herein are nutritional compositions that display enhanced bioavailability of certain lipophilic nutrients and related methods useful for improving the bioavailability of certain lipophilic nutrients. These nutritional compositions comprise protein sourced from cow's milk. In certain exemplary embodiments, the nutritional compositions comprise bovine beta-casein genetic variant A2. In certain exemplary embodiments, the nutritional compositions comprise bovine beta-casein genetic variant A2 as the predominant genetic variant of beta-casein present in the nutritional compositions. Nutritional compositions that comprise genetic variant A2 according to the general inventive concepts display enhanced delivery of lipophilic nutrients, especially in comparison to nutritional compositions including a conventional genetic variant profile, (such as A1 beta-casein as the predominant genetic variant of beta-casein). In addition, certain exemplary embodiments comprise monoglyceride and diglyceride oil (MDG oil), and in certain exemplary embodiments, a premix comprising MDG oil.

The term “nutritional composition” as used herein, unless otherwise specified, refers to nutritional powders, solids, semi-solids, liquids, and semi-liquids that comprise at least one of protein, carbohydrate, and lipid, and are suitable for oral administration to a subject. The nutritional composition may further comprise vitamins, minerals, and other ingredients and represent a sole, primary, or supplemental source of nutrition.

The terms “reconstitutable” or “reconstitutable powder” as used herein, unless otherwise specified, refers to powders that can be mixed with water or another aqueous liquid to create a liquid nutritional composition prior to consumption.

The terms “liquid nutritional composition” and “nutritional liquid” as used herein, unless otherwise specified, are used interchangeably to refer to nutritional products in ready-to-consume liquid form or concentrated liquid form.

The term “casein(s)” as used herein, unless otherwise specified, should be understood to refer to those proteins in bovine milk that will precipitate from the milk at a solution pH of 4.6 (20° C.); caseins typically make up about 80% of the protein in whole, undiluted, bovine milk. Generally, any type of milk-sourced protein source can be utilized for the nutritional compositions as a source of bovine beta-casein, including whole milk, nonfat dry milk, milk protein concentrate, total milk protein, milk protein isolate, acid casein, calcium caseinate, sodium caseinate, magnesium caseinate, purified beta-casein, and combinations thereof, all of which will contain beta-casein. Beta-casein comprises around 30% of the protein contained in cow's milk, and may be present as one of several genetic variants, the two most prevalent being genetic variants A1 and A2. Bovine beta-casein has further been categorized into genetic variants including A3, B, C, D, E, F, G, H1, H2, and I.

The term “lipophilic nutrient” as used herein, unless otherwise specified, refers to nutrients that have greater solubility in organic solvents such as ethanol, methanol, ethyl ether, acetone, chloroform, benzene and fats and oils than they have in water. For the purpose of this disclosure, the term “lipophilic nutrient” may be applied to other lipophilic moieties, including but not limited to pharmaceutical compounds. Non-limiting examples of certain lipophilic nutrients include vitamin A, vitamin D, vitamin E, vitamin K, carotenoids (e.g., lutein) among others.

The terms “fat,” “lipid,” and “oil” as used herein, unless otherwise specified, are used interchangeably to refer to lipid materials derived or processed from plants or animals. These terms also include synthetic lipid materials so long as such synthetic materials are suitable for administration to subjects as defined herein.

The term “glycerides” as used herein, unless otherwise specified, refer generally to lipophilic compounds comprising a glycerol molecule bonded to fatty acid groups. Monoglycerides are glycerol molecules bonded to a single fatty acid group; diglycerides are glycerol molecules bonded to two fatty acid groups; and triglycerides are glycerol molecules bonded to three fatty acid groups. Fats and oils comprise glycerides, and typical fats and oils from animal, fish, algae, vegetable, or seed sources are comprised primarily of triglycerides.

The term “activated” refers to an MDG oil or an MDG premix that has been blended with water or other aqueous liquid. The term “activation” refers to the step of blending the MDG oil or MDG premix with the aqueous liquid. For example, an “activated MDG oil component” or an “activated MDG premix component” means an aqueous liquid into which an MDG oil or an MDG premix has been blended. For the purpose of this disclosure, an activated MDG oil component is typically an aqueous liquid substantially free of oils or fats other than the MDG oil.

The term “human milk fortifier” as used herein, unless otherwise specified, refers to nutritional compositions suitable for mixing with breast milk, preterm infant formula or infant formula for consumption by a preterm or term infant.

The terms “adult formula” and “adult nutritional composition” as used herein, unless otherwise specified, are used interchangeably to refer to nutritional compositions for generally maintaining or improving the health of an adult.

The terms “infant formula” or “infant nutritional product” as used herein, unless otherwise specified, are used interchangeably to refer to nutritional compositions for generally maintaining or improving the health of infants. As used herein, the term infant refers to an individual between the ages of 0 and 36 months, including individuals that are less than 12 months of age.

The terms “pediatric formula” or “pediatric nutritional composition” as used herein, unless otherwise specified, are used interchangeably to refer to nutritional compositions for generally maintaining or improving the health of infants and children.

The terms “bioavailable” or “bioavailability” as used herein, unless otherwise specified, refers to the ability of a lipophilic nutrient to be absorbed from the gastrointestinal tract and subsequently will then enter into the bloodstream of an individual such that the substance can be absorbed into organs and tissues in the body. As the degree of bioavailability of a nutrient increases, the nutrient becomes more likely to enter into and remain in the bloodstream where it can be absorbed and used by the body. As the degree of bioavailability of a nutrient decreases, the compound becomes less likely to being absorbed into lymph from the gastrointestinal tract and would be excreted from the body before entering the bloodstream.

The term “shelf stable” or “shelf stability” as used herein, unless otherwise specified, refers to a nutritional composition, such as a nutritional emulsion, that remains commercially stable after being packaged and then stored at 18-24° C. for at least 3 months, including from about 6 months to about 24 months, and also including from about 12 months to about 18 months. The term commercially stable refers to a maintenance of levels of particular nutrients (including but not limited to lipophilic nutrients) at or above desired levels for delivery to the intended consumer.

All percentages, parts and ratios as used herein are by weight of the total product, unless specified otherwise. All such weights as they pertain to listed ingredients are based on the active level and, therefore, do not include solvents or by-products that may be included in commercially available materials, unless specified otherwise.

The various embodiments of the nutritional compositions of the present disclosure may include trace amounts of any optional or selected essential ingredient or feature described herein, provided that the remaining formulation still contains all of the required ingredients or features as described herein. In this context, and unless otherwise specified, the term “trace amount” means that the selected compositions contains no more than 2% by weight of the optional ingredient, typically less than 1% by weight, and also includes zero percent by weight of such optional or selected essential ingredient.

The various embodiments of the nutritional compositions discussed herein may also be substantially free of any optional ingredient or feature described herein, provided that the remaining composition still contains all of the required ingredients or features as described herein. In this context, and unless otherwise specified, the term “substantially free” means that the selected composition contains less than a functional amount of the optional ingredient, typically less than about 1%, including less than about 0.5%, including less than about 0.1%, and also including zero percent, by weight of such optional ingredient.

The compositions and methods according to the general inventive concepts may comprise, consist of, or consist essentially of the required elements of the exemplary embodiments described herein, as well as any additional or optional element described herein or otherwise useful in product applications.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

The discussion of the nutritional compositions herein, should be understood to apply equally to the nutritional compositions useful in the presented methods.

As previously mentioned, due to relatively low delivery, bioavailability, or both, many lipophilic nutrients must be overfortified in nutritional compositions in order to provide the requisite amount to the intended consumer. This overfortification results in increased costs for the producer of the nutritional composition and provides no corresponding benefit to the consumer. Thus, any reduction in this overfortification provides a benefit to the producer as well as to the consumer as overall costs to produce the nutritional composition can be lowered.

The general inventive concepts contemplate the use of A2 beta-casein in a nutritional composition containing a lipophilic nutrient whose absorption is desired to be enhanced.

### Beta-Casein

It has unexpectedly been shown that beta-casein is implicated in the delivery of certain lipophilic nutrients for absorption, digestion, or both. While not wishing to be bound by theory, it is believed that hydrophobicity of the casein is correlated with the ability to provide an effective delivery “vehicle” for certain lipophilic nutrients. A2 beta-casein is a relatively more hydrophobic form of beta-casein (compared to A1 beta-casein). An aspect of the general inventive concepts resides in the discovery that A2 beta-casein can act as a carrier to enhance the delivery of lipophilic nutrients (e.g., vitamin A, E, D, K and carotenes). It therefore follows that nutritional compositions that replace a portion of the inherent beta-casein with genetic variant A2 demonstrate enhanced bioavailability of certain lipophilic nutrients.

The majority of milk protein utilized in milk protein-containing products in the United States is from the cattle breed Holstein. The term “Holstein” as used herein should be understood to encompass the Holstein breed, the Friesian breed and cross-breeds of the two, so-called Holstein-Friesian cattle. Milk from Holstein cattle includes genetic variant A1 as the predominant genetic variant. In contrast, milk from the Bos indicus breed has genetic variant A2 as the predominant genetic variant. Similarly, milk from the Guernsey breed of Bos taurus has been shown to express high levels of beta-casein variant A2 and low levels of other beta-casein variants.

In certain exemplary embodiments, the nutritional compositions comprise protein including 10 to 100% bovine beta-casein. The bovine beta-casein comprises about 50 to about 100% genetic variant A2. Thus, as a non-limiting example, in a nutritional composition containing 10 grams of protein per serving, about 1-10 grams of that protein would be bovine-beta-casein, and about 0.5-10 grams of the protein would be genetic variant A2. In certain exemplary embodiments the bovine beta-casein comprises about 60% to about 100%, including about 70% to about 100%, including about 80% to about 100%, and including about 90% to about 100% by weight bovine beta-casein genetic variant A2.

The bovine beta-casein utilized in certain exemplary embodiments may be from a single source, or may alternatively be provided by a combination of sources. The bovine beta-casein according to certain exemplary embodiments will generally be found in milk protein isolates and milk protein concentrates, but may also be found in other milk protein sources such as whole milk, nonfat dry milk, milk protein concentrate, total milk protein, milk protein isolate, acid casein, calcium caseinate, sodium caseinate, magnesium caseinate, purified beta-casein, and combinations thereof. It may be possible to purify a milk protein isolate (or another milk protein source) containing unacceptably high levels of less-desirable genetic variants (i.e., those other than A2). Non-limiting examples of purification methods useful for reducing unacceptably high levels of beta-casein genetic variants include: a preparative chromatographic process (e.g., affinity chromatography, ion exchange chromatography, reversed phase chromatography) or by a selective salt precipitation (e.g., ammonium sulfate). Alternatively, a milk protein source (such as milk protein isolate or milk protein concentrate) containing milk sourced from primarily non-Holstein cattle, and hence, reduced quantities of genetic variants other than A2 may also be utilized in the nutritional compositions and methods disclosed herein.

The term milk protein concentrate is generally used to refer to a milk protein containing product that has had a considerable amount of the inherent water from ordinary milk removed and also has had inherent fat from the ordinary milk removed. The term milk protein isolate is generally used to refer to a type of milk-protein containing product that has not only had a considerable amount of the inherent water from ordinary milk removed and inherent fat but also a certain amount of inherent lactose removed. In most instances, milk protein isolates can be considered to be a type of further purified milk protein concentrate. Certain manufacturers may use the term milk protein concentrate to refer to milk-based protein products even if they contain at least 85 weight % protein.

The protein in the nutritional compositions according to certain exemplary embodiments, may be provided by a single source of protein or a combination of protein sources. As previously discussed, about 10 to about 100% by weight of the protein present in the nutritional composition comprises bovine beta-casein. The remaining portion of the protein (i.e., 0-90% by weight of the total protein present in the nutritional composition) can be selected from one or more other sources. As discussed in more detail below, these additional sources of protein are not particularly limited and may include one or more of soy protein, whey protein or any other protein source, including but not limited to those discussed herein. (Furthermore, it should be understood that the source for the remaining portion of the protein could also be selected from milk protein isolate, milk protein concentrate, caseinates, or non-fat dry milk that does not meet the previously discussed requirements as long as these components are not present in amounts so high as to violate other limitations on the amounts of genetic variants discussed previously).

### Lipophilic Nutrient

As previously discussed, the nutritional compositions comprise one or more lipophilic nutrients, the bioavailability of which may be improved in accordance with the general inventive concepts.

Suitable non-limiting examples of lipophilic nutrients may be selected from the group of fat-soluble vitamins, carotenoids, steroids, ubiquinones, gangliosides, phosphoinositides, lipoproteins, phospholipids, glycolipids, glycophospholipids, and combinations thereof. In certain exemplary embodiments, the lipophilic nutrient may be selected from the group of vitamin A, vitamin D, vitamin E, vitamin K, lutein, zeaxanthin, astaxanthin, alpha- or beta-cryptoxanthin, retinol, lycopene, beta-carotene, Coenzyme Q₁₀, lipoprotein, phospholipid, glycolipid, glycophospholipid, and combinations thereof. In certain exemplary embodiments, the lipophilic nutrient is selected from a carotenoid, a lipid soluble vitamin, a lipophilic antioxidant, and combinations thereof. In certain exemplary embodiments, the lipophilic nutrient is selected from vitamin A, vitamin D, and vitamin E. The lipophilic nutrients in the nutritional compositions may be from a single source, or may alternatively be provided by a combination of sources.

In order to provide enhanced bioavailability, stability, delivery, or combinations thereof, of the lipophilic nutrient(s), the lipophilic nutrient is present in the nutritional composition in an amount relative to the amount of beta-casein present in the nutritional composition. In certain exemplary embodiments, the molar ratio of A2 beta-casein to the lipophilic nutrient is from about 10:1 to about 10,000:1. In certain exemplary embodiments, the molar ratio of A2 beta-casein to the lipophilic nutrient is from about 25:1 to about 4000:1.

Table 1 shows an example of amounts of a group of lipophilic nutrients and the ratio of the lipophilic nutrients relative to the amount of beta-casein in an exemplary nutritional composition suitable for consumption by an infant.

TABLE 1

| | | Ratio of β-casein to |
|---|---|---|
| | Concentration, μM | lipophilic nutrient, molar, |
| Nutrient | (approximate) | approx. |
| β-casein (~2.40 g/L) | 102 | N/A |
| vitamin A (2029 IU/L) | 2.12 | 50 |
| vitamin D (406 IU/L) | 0.026 | 4000 |
| vitamin E (10.1 IU/L) | 0.016 | 6400 |
| vitamin K (54 μg/L) | 0.120 | 900 |
| Lutein (50 μg/L) | 0.088 | 1200 |

The nutritional compositions according to the present disclosure may include the lipophilic nutrient in any amount that is sufficient for the intended purpose.

In certain exemplary embodiments, the nutritional compositions are in a powder form and comprise a lipophilic nutrient, for example vitamin A, in an amount of at least about 400 micrograms per 100 grams of powder, including from about 0.2 to about 3 milligrams, including from about 0.3 to about 2 milligrams, including from about 0.4 milligrams to about 1 milligram per 100 grams of powder.

In certain exemplary embodiments, the nutritional compositions are in a powder form and comprise a lipophilic nutrient, for example vitamin D, in an amount of at least about 7 micrograms per 100 grams of powder, including from about 0.005 to about 0.1 milligrams, including from about 0.006 to about 0.5 milligrams, including from about 0.007 to about 0.025 milligrams per 100 grams of powder.

In certain exemplary embodiments, the nutritional compositions are in a powder form and comprise a lipophilic nutrient. Upon reconstituting the powdered nutritional compositions at a rate of, for example, 100 grams of nutritional powder per 23 ounces of liquid (e.g., water), the lipophilic nutrient concentrations may range from about 5 micrograms per liter (μg/L) to about 250 mg/L of the reconstituted nutritional compositions, including from about 10 μg/L to about 250 mg/L, including from about 50 μg/L to about 150 mg/L, including from about 75 μg/L to about 100 mg/L, and also including from about 50 μg/L to about 50 mg/L, as calculated on a ready-to-feed basis. More particularly, when used in infant formulas, the lipophilic nutrient concentrations range from about 5 μg/L to about 250 μg/L, including from about 10 μg/L to about 250 μg/L, and also including from about 50 μg/L to about 200 μg/L, as calculated on a ready-to-feed basis. When used in an adult formula, the lipophilic nutrient concentrations may range from about 5 μg/L to about 250 mg/L, including from about 10 μg/L to about 250 mg/L, including from about 50 μg/L to about 200 mg/L, including from about 100 μg/L to about 150 mg/L, also including from about 1 mg/L to about 150 mg/L, as calculated on a ready-to-feed basis.

### Monoglyceride and Diglyceride Oil

As previously mentioned, in certain exemplary embodiments, the nutritional compositions comprise, in addition to the bovine beta-casein and lipophilic nutrient(s), a mixture of monoglyceride and diglyceride oil (“MDG oil”). Natural sources of MDG oil include animal fats, such as animal-derived (e.g., cow- or hog-derived) glycerides, or vegetable oils, such as glycerides derived from corn, soybean, sunflower, safflower and coconut oil. In some embodiments, the mixture of monoglycerides and diglycerides may be derived from the hydrolysis of triglycerides in safflower, corn, or sunflower oil. In certain exemplary embodiments, the fatty acid groups present in the monoglycerides, diglycerides, and triglycerides may be the same or different. Similarly, any free fatty acids in the MDG oil may be the same as or different from the fatty acid groups in the monoglycerides, diglycerides, or triglycerides.

Nutritional compositions according to the general inventive concepts are characterized by improved bioavailability of a lipophilic nutrient. Without wishing to be bound by theory, it is believed that the MDG oil or the activated MDG oil component, (in addition to the A2 beta-casein) facilitates efficient delivery of the lipophilic nutrient to the intestine and absorption into the body. By enhancing the bioavailability of the lipophilic nutrient in the nutritional compositions, the user of the product is more likely to receive the desired amount of the nutrient without the need to over-fortify the composition. Thus the cost of the composition may be reduced.

In certain exemplary embodiments, the nutritional compositions comprise MDG oil in an amount of from about 0.0001 grams to no more than about 95 grams, including from about 0.001 grams to about 50 grams, including from about 0.0072 grams to about 25 grams, including from about 0.0072 grams to about 2.60 grams, including from about 0.01 grams to about 10 grams, including from about 0.1 grams to about 7.5 grams, and also including from about 0.50 grams to about 5 grams, of monoglycerides and diglycerides per 100 grams of fat in the nutritional composition. In some embodiments, the composition may include from about 0.01 grams to no more than about 10 grams of monoglycerides and diglycerides sourced from the premix per 100 grams of fat. It is to be understood that when discussing the monoglycerides and diglycerides, that the discussion should apply equally to premix(es) comprising the MDG oil.

In certain exemplary embodiments, the nutritional compositions comprise MDG oil comprising monoglycerides in an amount of at least 12%, including from 12% to about 98%, and also including from about 20% to about 80%, including from about 20% to about 60%, and including from about 25% to about 50% by weight of the premix (excluding the weight of the lipophilic compound). It will be recognized by one skilled in the art based on the disclosure herein that the premix may include a small percentage of impurities such that the mixture of monoglycerides and diglycerides is not 100% by weight solely monoglycerides and diglycerides. In certain exemplary embodiments, the impurity may be a triglyceride and/or free glycerol. These impurities may typically be less than about 20%, less than about 15%, less than about 10%, or less than about 2% by weight. In embodiments in which the premix comprises monoglycerides and impurities, the balance of the premix (excluding the lipophilic compound) is diglycerides.

In certain exemplary embodiments, the nutritional compositions comprise MDG oil in amounts of from about 0.05 gram to no more than about 95 grams, including from about 0.06 gram to about 50 grams, including from about 0.1 gram to about 25 grams, including from about 0.25 gram to about 10 grams, including from about 0.5 gram to about 7.5 grams, and also including from about 1 gram to about 5 grams, of MDG oil per 100 grams of total fat in the nutritional composition. In some embodiments, the composition may include from about 0.05 gram to no more than about 20 grams of MDG oil per 100 grams of total fat.

To provide effective amounts of the lipophilic nutrient and the MDG oil in the nutritional compositions, the lipophilic nutrient is present in amounts relative to the amount of the MDG oil in a given nutritional composition. Typically, the ratio of the amount of the lipophilic nutrient to the amount of the MDG oil in the nutritional composition should be from about 0.00005:1 to about 1:1 (wt lipophilic nutrient:wt MDG oil). For example, the lipophilic nutrient may be present in an amount of about 100 g, about 90 g, about 80 g, about 70 g, about 60 g, about 50 g, about 40 g, about 20 g, about 5 g, about 1 g, about 500 mg, about 100 mg, about 50 mg, about 10 mg, or about 5 mg, of lipophilic nutrient per 100 g of the MDG oil in the premix. Other ratios of the lipophilic nutrient to the MDG oil are within the scope of the present disclosure, so long as the lipophilic nutrient is completely or substantially dissolved, dispersed, or suspended in the resulting premix. Based on the disclosure herein, one skilled in the art may calculate suitable ratios that will allow an effective amount of both the lipophilic nutrient and the MDG oil to be incorporated into the nutritional composition.

In certain exemplary embodiments, it may be desirable to combine one or more lipophilic nutrients with the MDG oil prior to addition to the remainder of the nutritional composition. In certain exemplary embodiments, the lipophilic nutrient may be mixed with the MDG oil in the presence of heat or at ambient temperature and, in some embodiments, with agitation to allow the lipophilic nutrient to dissolve, disperse or suspend into the MDG oil.

These and other elements or limitations of the nutritional compositions and methods of making and using them are described in further detail hereafter.

### Product Form

In certain exemplary embodiments, the nutritional compositions comprise, in general, A2 beta-casein and a lipophilic nutrient. In certain exemplary embodiments, the nutritional compositions comprise A2 beta-casein, a lipophilic nutrient, and an MDG oil.

The nutritional compositions may be in any useful form. Non-limiting nutritional composition forms include ready-to-drink liquids, concentrated liquids, gels, and powders. In certain exemplary embodiments, the composition may be in the form of a flowable or substantially flowable powder. In certain exemplary embodiments, the composition may be in the form of a powder that can be easily scooped and measured with a spoon or similar other device, such that the composition can be reconstituted with a suitable liquid, typically water, to form a liquid nutritional composition for immediate consumption. In this context, “immediate” use generally means within about 48 hours, most typically within about 24 hours, and in some embodiments, immediately after reconstitution.

Further, non-limiting examples of nutritional compositions include human milk fortifiers, preterm infant formulas, infant formulas, elemental and semi-elemental formulas, pediatric formulas, adult formulas, and nutritional supplements.

Nutritional compositions may have a caloric density tailored to the nutritional needs of the ultimate user. In typical instances, nutritional compositions may comprise from about 65 to about 800 kcal/240 mL, including from about 90 to about 350 kcal/240 mL, and also including from about 150 to about 320 kcal/240 mL. Other caloric densities are within the scope of the present disclosure.

In certain exemplary embodiments, the nutritional compositions may be packaged and sealed in single or multi-use containers, and then stored under ambient conditions or under refrigeration for up to 36 months or longer, more typically from about 6 months to about 24 months. For multi-use containers, these packages can be opened and then closed for repeated use by the ultimate user. For liquid embodiments, the opened and subsequently closed package is typically stored under refrigerated conditions, and the contents used within about 7 days. For powdered embodiments, the opened and subsequently closed package may be typically stored under ambient conditions, avoiding extreme temperatures, and the contents used within about one month. Non-limiting examples of ways in which the present nutritional compositions may be utilized include use as the following products: a beverage (e.g., a coffee beverage, a cocoa or chocolate beverage, a malted beverage, a fruit or juice beverage, a carbonated beverage, a soft drink, or a milk based beverage); a performance nutrition product (e.g., a performance nutrition bar, powder or ready-to-drink beverage); a dairy product (e.g., a milk drink, a yogurt, or an ice cream product); a confectionary product (e.g., a chocolate product); or a functional food or beverage (e.g., a slimming product, a fat burning product, a product for improving mental performance or preventing mental decline, or a skin improving product). A beverage according to the invention may be in the form of, for example, a powder or liquid concentrate to be mixed with a suitable liquid (e.g., water or milk) before consumption, or may be in the form of a ready-to-drink beverage.

### Macronutrients

In certain exemplary embodiments, the nutritional compositions comprise a macronutrient selected from the group of protein (including A2 beta-casein), fat (in addition to the MDG oil discussed above), carbohydrate, and mixtures thereof. Generally, any source of protein, fat, or carbohydrate that is known or otherwise suitable for use in nutritional products may also be suitable for use herein, provided that such macronutrients are also compatible with the essential elements of the nutritional compositions as defined herein.

Although total concentrations or amounts of protein, fat, and carbohydrates may vary depending upon the nutritional needs of the intended user, such concentrations or amounts most typically fall within one of the following embodied ranges, inclusive of any other essential fat, protein, and or carbohydrate ingredients as described herein.

Protein concentrations (including the A2 beta-casein) typically range from about 0.5% to about 85%, from about 0.5% to about 50%, from about 0.5% to about 32%, or from about 1% to about 15%, by weight of the nutritional composition. Fat concentrations (including the MDG oil) typically range from about 0.5% to about 35%, including from about 0.5% to about 20%, including from about 1% to about 15%, and also including from about 2% to about 10%, by weight of the nutritional composition. Carbohydrate concentrations typically range from about 5% to about 70%, including from about 7% to about 50%, including from about 10% to about 30%, by weight of the nutritional composition. Additional exemplary ranges for carbohydrates, fats, and proteins, based on % calories of the nutritional composition, are set forth in Table 2.

TABLE 2

| Macronutrient | (% Calories) | (% Calories) | (% Calories) |
|---|---|---|---|
| Carbohydrate | 1-98 | 0-75 | 30-50 |
| Fat | 1-98 | 20-70 | 35-40 |
| Protein | 1-98 | 5-85 | 15-85 |

Note:
Each numerical value in the table is preceded by the term “about.”

The particular amount of protein present in the nutritional composition may vary depending upon the nutritional needs of the intended user. In addition to the values expressed above, the amount of protein may alternatively be expressed as a percentage of the weight of the nutritional composition. In such embodiments, protein is present in an amount of 1 to 25% of the total weight of the nutritional composition, including 1-25%, including 1 to 20%, including 2 to 12%, including 3 to 10% by weight of the nutritional compositions.

Various commercial sources of protein exist and may be utilized in the nutritional compositions disclosed herein. The protein may be provided by one source and, in certain embodiments, more than one source of protein. Non-limiting examples of suitable protein (in addition to the A2 beta-casein) or sources thereof in the nutritional compositions may be selected from the group of partially hydrolyzed or non-hydrolyzed proteins derived from any suitable source, such as milk (e.g., casein or whey), animal (e.g., meat or fish), cereal (e.g., rice or wheat), vegetable (e.g., pea, potato, or bean), or combinations thereof. Non-limiting examples of such proteins include whole cow's milk, partially or completely defatted milk, milk protein isolates, milk protein concentrates, caseinates, casein protein isolates, whey protein, whey protein concentrates, soy protein isolates, soy protein concentrates, pea protein isolates, pea protein concentrates, hydrolyzed yeast, potato, rice, wheat, canola, animal collagen, gelatin, bovine colostrum, human colostrum, glycomacropeptides, mycoproteins, amino acids, and combinations thereof.

As previously discussed, in certain exemplary embodiments, the nutritional compositions include fats (in addition to the MDG oil). The particular amount of fat present in the nutritional composition may vary depending upon the nutritional needs of the intended user. In addition to the values expressed above, the amount of fat may alternatively be expressed as a percentage of the weight of the nutritional composition. In such embodiments, the amount of fat is within the range of about 0.5 to 60% by weight of the nutritional composition, including about 0.5 to 35% by weight, about 0.5 to 20% by weight, about 1 to 15% by weight, and about 2 to 15% by weight of the nutritional compositions.

Various commercial sources of fats exist and may be utilized in the nutritional compositions disclosed herein. The fat may be provided by one source and, in certain embodiments, more than one source of fat. Non-limiting examples of suitable fats (in addition to the MDG oil) in the nutritional compositions described herein may be selected from the group of coconut oil, fractionated coconut oil, soy oil, corn oil, olive oil, safflower oil, high oleic safflower oil, medium chain triglyceride oil, sunflower oil, high oleic sunflower oil, palm and palm kernel oils, palm olein, canola oil, marine oils, cottonseed oil, borage oil, algal oil, fungal oil, and combinations thereof.

As previously discussed, in certain exemplary embodiments, the nutritional compositions include carbohydrates. The particular amount of carbohydrates present in the nutritional composition may vary depending upon the nutritional needs of the intended user. In addition to the values expressed above, the amount of carbohydrates may alternatively be expressed as a percentage of the weight of the nutritional composition. In such embodiments, carbohydrates are present in an amount of about 5 to 70% by weight of the nutritional composition, including about 10 to 60% by weight of the nutritional composition, including 10 to 35%, including 5 to 25% by weight of the nutritional composition.

Various commercial sources of carbohydrates exist and may be utilized in the nutritional compositions disclosed herein. The carbohydrates may be provided by one source and, in certain embodiments, more than one source of carbohydrates. Non-limiting examples of suitable carbohydrates or sources thereof for use in the nutritional compositions disclosed herein include maltodextrin, hydrolyzed or modified starch or cornstarch, glucose polymers, corn syrup, corn syrup solids, rice-derived carbohydrates, glucose, fructose, lactose, high fructose corn syrup, honey, sugar alcohols (e.g., malitol, erythritol, sorbitol), slowly digesting carbohydrates, sources of soluble fibers such as resistant starches, gum arabic, pectins, beta-glucans, and the like and combinations thereof.

### Optional Ingredients

In certain exemplary embodiments, the nutritional compositions comprise optional ingredients that may modify the physical, chemical, hedonic or processing characteristics of the products or serve as additional nutritional components when used for a targeted population. Many such optional ingredients are known or otherwise suitable for use in other nutritional products and may also be used in the compositions described herein, provided that such optional ingredients are safe and effective for oral administration and are compatible with the essential and other ingredients in the selected product form.

Non-limiting examples of such optional ingredients include preservatives, antioxidants, emulsifying agents, buffers, additional nutrients as described herein, colorants, flavors, thickening agents and stabilizers, and so forth.

The nutritional compositions may further comprise additional vitamins or related nutrients, non-limiting examples of which include vitamin K, thiamine, riboflavin, pyridoxine, vitamin B12, carotenoids (in addition to those discussed above), niacin, folic acid, pantothenic acid, biotin, vitamin C, choline, inositol, salts, and derivatives thereof, and combinations thereof.

The nutritional compositions may further comprise minerals, non-limiting examples of which include calcium, phosphorus, magnesium, iron, zinc, manganese, copper, sodium, potassium, molybdenum, chromium, selenium, chloride, and combinations thereof.

In certain exemplary embodiments, the nutritional compositions may also include one or more masking agents to reduce or otherwise obscure bitter flavors and after taste. Suitable masking agents include natural and artificial sweeteners, sodium sources such as sodium chloride, and hydrocolloids, such as guar gum, xanthan gum, carrageenan, gellan gum, and combinations thereof. The amount of masking agent in the composition may vary depending upon the particular masking agent selected, other ingredients in the composition, and other composition or product target variables. Such amounts, however, most typically range from at least 0.1%, including from about 0.15% to about 3.0%, and also including from about 0.18% to about 2.5%, by weight of the composition.

### Methods of Manufacture

The various embodiments of nutritional compositions having improved bioavailability of one or more lipophilic nutrients may be prepared by any process or suitable method for making the selected product form, such as a liquid or semi-liquid nutritional composition.

In certain exemplary embodiments, a premix comprising monoglycerides and diglycerides is provided. The premix is added to an aqueous solution, for example to a protein-in-water slurry, to form an “activated premix.” The activated premix is then added to the composition which comprises a lipophilic compound.

Notably, to form an “activated premix,” the premix may not be added to a quantity of oil that is sufficient to cause the monoglycerides and diglycerides to disassociate in the oil prior to the addition of the premix into the aqueous solution.

In one suitable manufacturing process for preparing emulsion-type liquid nutritional compositions, for example, at least three separate slurries are prepared, including a protein-in-fat (PIF) slurry, a carbohydrate-mineral (CHO-MIN) slurry, and a protein-in-water (PIW) slurry. The PIF slurry is formed by heating and mixing an oil (e.g., soy oil, canola oil, or corn oil) and then adding an emulsifier (e.g., lecithin), fat soluble vitamins, and a portion of the total protein (e.g., milk protein concentrate) with continued heat and agitation. The CHO-MN slurry is formed by adding with heated agitation to water: minerals (e.g., potassium citrate, dipotassium phosphate, or sodium citrate), including trace and ultra trace minerals (TM/UTM premix), and thickening or viscosity agents (e.g., cellulose gel, gellan, or carrageenan). The resulting CHO-MIN slurry is held for 10 minutes with continued heat and agitation before adding additional minerals (e.g., potassium chloride, magnesium carbonate, or potassium iodide) and the carbohydrates (e.g., sucrose or corn syrup). The PIW slurry is then formed by mixing water and the remaining protein with heat and agitation.

In accordance with this process, the three slurries are blended together with heat and agitation and the pH is adjusted to the desired range, e.g., from 6.6 to 7, after which the composition is subjected to high-temperature short-time (“HTST”) processing. The composition is heat treated, emulsified, homogenized, and cooled during the HTST process. Water soluble vitamins and ascorbic acid are added (if applicable), the pH is again adjusted (if necessary), flavors are added and any additional water can be added to adjust the solids content to the desired range.

The MDG oil can be combined with the other ingredients of the nutritional composition at any useful point during the manufacturing process. Specifically, the MDG oil may be added to any of the individual slurries, may be added to the three-slurry blend, or may be added to the nutritional composition at any point after the slurries are blended.

The MDG oil may also be activated by blending the MDG oil with an aqueous liquid during the manufacturing process. This activation step may occur at various points during the process. For example, the MDG oil may be blended with water or other aqueous liquid to form an activated MDG oil component. This activated MDG oil component may be added to an individual slurry, to the three-slurry blend, or to the nutritional composition at any point after the slurries are blended. Alternatively, the MDG oil may be blended with an aqueous slurry containing other components of the nutritional composition, provided, however, that the aqueous slurry is substantially free of fats or oils. For example, the MDG oil may be blended into a protein-in-water (PIW) slurry. The PIW slurry may be formed by mixing proteins, such as casein, into water with heat and agitation. The MDG oil may be blended with the PIW slurry to activate the MDG oil and form an activated MDG oil component. Similarly, the MDG oil may be blended with the CHO-MIN slurry to form an activated MDG oil component. The aqueous slurry containing the activated MDG oil may be blended with the other components of the nutritional composition, as described above.

When an activated MDG oil component is subsequently added to a fat-containing composition, such as a liquid nutritional composition, some or all of the monoglycerides and diglycerides in the activated MDG oil component are not disassociated by the fat in the composition, but instead remain in the aqueous phase of the nutritional composition. To determine the amount of the monoglycerides and diglycerides that are not disassociated in the fat (i.e., remain in the aqueous phase), the “Disassociated MDG Test” may be utilized.

The Disassociated MDG Test is described as follows. The fat-containing composition that also contains an activated MDG oil component is subjected to high speed centrifugation (31,000×g, 20° C., 4 h) to separate the lipid and aqueous fractions. The resulting aqueous fraction is subjected to HPLC analysis for monoglyceride and diglyceride content as described in “Determination of food emulsifiers in commercial additives and food products by liquid chromatography/atmospheric-pressure chemical ionization mass spectrophotometry,” by M. Suman et al, Journal of Chromatography A, 1216 (2009) 3758-3766. The amount of monoglycerides and diglycerides quantified in the aqueous fraction is compared to the amount that was added to the fat-containing composition, and the percentage of the monoglycerides and diglycerides that are not disassociated by the fat is calculated.

Using the Disassociated MDG Test, one may determine the effectiveness of using an activated MDG oil component versus an unactivated MDG oil in a nutritional composition. This may be accomplished by quantifying the monoglycerides and diglycerides in the aqueous fractions of compositions comprising activated and unactivated oils or premixes. The aqueous fraction of the composition comprising the activated MDG oil component will contain a higher amount of monoglycerides and diglycerides than the same composition in which the MDG oil has not been activated. In exemplary embodiments, the content of monoglycerides and diglycerides in the aqueous fraction of the composition comprising the activated MDG oil component may be at least about 1% higher, at least about 5% higher, or at least about 10% higher than in the same composition that comprises an unactivated MDG oil.

In certain exemplary embodiments, the MDG premix also comprises all or part of lipophilic nutrient in the composition. The lipophilic nutrient is mixed with the other premix ingredients in the presence of heat or at ambient temperature and, in some embodiments, with agitation to allow the lipophilic nutrient to dissolve, disperse or suspend in the premix. The MDG premix containing the lipophilic nutrient is blended with a fat-containing solution, preferably the PIF slurry, to form an MDG-protected component. The MDG component is added to the nutritional composition at any useful point during the manufacturing process, as described above.

After all slurries and other ingredients of the nutritional composition have been blended together and the liquid nutritional composition has been fully processed, the liquid nutritional composition optionally may be packaged and sterilized according to any suitable sterilization technique (e.g., aseptic, retort, hot-fill, chemical, radiation, or filtering sterilization techniques).

In certain exemplary embodiments, the nutritional compositions may then be dried to form a powdered composition using any methods known in the art. By way of example, nutritional powders can be prepared by preparing at least two slurries that will later be blended, heat treated, standardized, heat treated a second time, evaporated to remove water, and spray dried or dry blended to form a reconstitutable powdered nutritional composition.

The spray dried powdered composition or dry blended powdered composition may be prepared by any collection of known or otherwise effective techniques, suitable for making and formulating a nutritional powder. For example, the spray drying step may likewise include any spray drying technique that is known for or otherwise suitable for use in the production of nutritional powders. Many different spray drying methods and techniques are known for use in the nutrition field, all of which are suitable for use in the manufacture of the spray dried powdered nutritional compositions herein. Following drying, the finished powder may be packaged into suitable containers.

The nutritional compositions described herein (i.e., those containing increased amounts of bovine beta-casein variant A2) should exhibit other advantages as compared to those nutritional compositions containing higher amounts of other bovine beta-casein variants. For example, a nutritional composition comprising a beta-casein source according to the current disclosure should exhibit increased solubility, increased hydrophobicity (resulting in better emulsifying capacity) and a decrease in any destabilizing of particular lipophilic nutrients present in the nutritional composition. Overall, an increase in emulsifying capacity can be measured through greater physical stability over shelf life of a nutritional composition, and can be evaluated by measuring factors such as separation of the composition and sedimentation (or lack thereof).

### EXAMPLES

The following examples illustrate specific and exemplary embodiments and features of the nutritional compositions disclosed herein. The examples are provided solely for the purposes of illustration and should not be construed as limitations of the present disclosure. Numerous variations over these specific examples are possible without departing from the spirit and scope of the general inventive concepts. All amounts indicated within the tables below are weight percentages based upon the total weight of the composition, unless indicated otherwise.

TABLE 3

| | Current commercial | Invention |
|---|---|---|
| Protein system | formulation | formulation |
| 64% nonfat dry milk | NFDM from | NFDM from |
| (NFDM), 36% WPC | Holstein-Friesian | Guernsey breed |
| | breeds | |
| Total protein | 2.07 g per 100 kcal | 2.07 g per 100 kcal |
| concentration | | |
| Total β-casein | 0.36 g per 100 kcal | 0.36 g per 100 kcal |
| concentration | | |
| Major genetic variant | A1 | A2 |
| of β-casein | | |

Table 4 shows partial composition information (protein content) for a commercial liquid nutritional composition designed for individuals with diabetes, compared with an exemplary liquid nutritional composition according to the embodiments disclosed herein. Both illustrate liquid nutritional product with varying sources of caseinates, and have a caseinate, SPC combination. The beta-casein utilized in the embodiment on the right is sourced from Bos indicus has A2 as the major genetic variant.

TABLE 4

| | Current commercial | Invention |
|---|---|---|
| Protein system | formulation | formulation |
| 80% caseinates, | Caseinates | Caseinates |
| 20% SPC | from Bos taurus | from Bos indicus |
| | milk, Holstein- | milk |
| | Friesian breeds | |
| Total protein | 76 g per liter | 76 g per liter |
| concentration | | |
| Total β-casein | 22 g per liter | 22 g per liter |
| concentration | | |
| Major genetic variant | A1 | A2 |
| of β-casein | | |

An exemplary liquid nutritional composition intended for infants and suitable for utilizing the protein disclosed herein is described in Table 5 below. The 14 grams of protein per liter of nutritional composition comprises about 18% by weight bovine beta-casein.

TABLE 5

| | Amount per 1000 | |
|---|---|---|
| Ingredient Name | Kg batch | Kg/g/mg |
| Ingredient Water | Q.S. | Kg |
| Nonfat Milk | 83.00 | Kg |
| Lactose | 51.82 | Kg |
| High Oleic Safflower Oil | 13.06 | Kg |
| Soy Oil | 10.50 | Kg |
| Coconut Oil | 9.256 | Kg |
| Galacto-oligosaccharides | 8.630 | Kg |
| Whey Protein Concentrate | 6.075 | Kg |
| 5% Potassium Hydroxide | 2.494 | Kg |
| KOH | 124.7 | g |
| Potassium Citrate | 536.6 | g |
| Calcium Carbonate | 449.9 | g |
| Ascorbic Acid | 446.9 | g |
| ARASCO Mortierella Alpina Oil | 359.3 | g |
| Soy Lecithin | 339.7 | g |
| Myverol 18-06 | 339.7 | g |
| Nucleotide-Choline Premix | 293.2 | g |
| Choline Bitartrate | 51.75 | g |
| Cytidine 5′-Monoohosohate | 30.49 | g |
| Disodium Guanosine 5′-Monophosphate | 15.64 | g |
| Disodium Uridine 5′-Monophosphate | 13.15 | g |
| Adenosine 5′-Monophosphate | 11.60 | g |
| Potassium Chloride | 199.9 | g |
| Magnesium Chloride | 154.0 | g |
| Vit/Min/Taur Premix | 149.9 | g |
| Taurine | 45.83 | g |
| m-lnositol | 33.28 | g |
| Zinc Sulfate | 15.35 | g |
| Niacinamide | 9.781 | g |
| Calcium Pantothenate | 5.865 | g |
| Ferrous Sulfate | 5.131 | g |
| Cupric Sulfate | 1.800 | g |
| Thiamine Chloride HCI | 1.518 | g |
| Riboflavin | 669.3 | g |
| Pvridoxine HCI | 613.1 | mg |
| Folic Acid | 206.1 | mg |
| Manganese Sulfate | 174.6 | mg |
| Biotin | 59.21 | mg |
| Sodium Selenate | 35.51 | mg |
| Cyanocobalamin | 4.722 | mg |
| DHASCO Crypthecodinium Cohnii Oil | 131.0 | g |
| Choline Chloride | 123.7 | g |
| Seakem GP-359 | 120.0 | g |
| Ultra-Micronized Tricalcium Phosphate | 103.2 | g |
| Potassium Phosphate Monobasic | 90.6 | g |
| Vitamin A, D3, E, K1 Premix | 64.7 | g |
| RRR Aloha-Tocophervl Acetate | 9.063 | g |
| Vitamin A Palmitate | 1.725 | g |
| Vitamin K1 (Phylloquinone) | 100.3 | mg |
| Vitamin D3 | 14.06 | mg |
| Ferrous Sulfate | 60.9 | g |
| Seakem RLC Carrageenan | 60.0 | g |
| Carotenoid Premix | 57.1 | g |
| Lutein | 119.9 | mg |
| Lycopene | 119.9 | mg |
| Beta- Carotene | 25.98 | mg |
| Sodium Chloride | 40.1 | g |
| Citric Acid (Processing Aid) | 29.8 | g |
| L-Carnitine | 3.62 | g |
| Riboflavin | 2.18 | g |

An exemplary liquid nutritional composition suitable for utilizing the protein disclosed herein is described in Table 6 below. The 34 grams of protein per liter of nutritional composition comprises about 25% by weight bovine beta-casein.

TABLE 6

| Ingredient | Kg per 1000 Kg |
|---|---|
| Water | Q.S. |
| Sucrose | 75.0 |
| Milk Protein Isolate (Alapro 4900- Fonterra) | 34.9 |
| Soy Oil | 8.0 |
| Soy Protein Isolate | 3.7 |
| Potassium Citrate | 3.3 |
| Phytosterol Ester | 3.2 |
| Avicel CL611 | 3.0 |
| Magnesium Phosphate Dibasic | 1.92 |
| N&A Vanilla Flavor | 1.80 |
| m-TCP | 1.75 |
| N&A Dairy Cream Flavor 32122 | 1.30 |
| Soy Lecithin | 1.0 |
| Magnesium Chloride | 1.15 |
| Sodium Chloride | 0.75 |
| Choline Chloride | 0.53 |
| Ascorbic Acid | 0.377 |
| Potassium Chloride | 0.309 |
| Potassium Hydroxide 45% (Processing Aid) | 0.262 |
| WSV Premix | 0.185 |
| Corn Starch (Processing Aid) | 0.0631143 |
| Dextrose (Processing Aid) | 0.062977 |
| Niacinamide | 0.0274725 |
| d-Calcium Pantothenate | 0.0177239 |
| Thiamine Chloride Hydrochloride | 0.0045325 |
| Pyridoxine Hydrochloride | 0.0043625 |
| Riboflavin | 0.0035335 |
| Folic Acid | 0.0006739 |
| Biotin | 0.0005467 |
| Cyanocobalamin | 0.00006318 |
| Carrageenan (Viscarin SA-359) | 0.180 |
| UTM/TM Premix | 0.150 |
| Zinc Sulfate, Monohydrate | 0.0837855 |
| Maltodextrin (Processing aid) | 0.0346267 |
| Manganese Sulfate, Monohydrate | 0.0207663 |
| Citric acid, Anhydrous | 0.009258 |
| Chromium Chloride, Hexahydrate | 0.0007288 |
| Sodium Molybdate, Dihydrate | 0.0005882 |
| Sodium Selenate, Anhydrous | 0.0002465 |
| Vitamin ADEK Premix | 0.135 |
| Coconut Oil (Processing Aid) | 0.0799578 |
| Vitamin E (dl-Alpha Tocophervl Acetate) | 0.0495827 |
| Vitamin A Palmitate | 0.0051266 |
| Phylloquinone | 0.000297 |
| Vitamin D3 | 0.00003594 |
| Sucralose Liquid (25%) | 0.10 |
| Seakem CM514 | 0.090 |
| Acesulfame potassium | 0.050 |
| Potassium Iodide | 0.00023 |

In certain exemplary embodiments disclosed herein, the nutritional compositions are administered (or consumed) orally as needed to provide the desired level of nutrition. In certain of these embodiments, the nutritional compositions are administered (or consumed) in the form of one to two servings daily or in one or two or more divided doses daily. In certain embodiments, when the nutritional composition is a liquid, the serving may be 150 milliliters to 500 milliliters. In certain other embodiments, when the nutritional composition is a liquid, the serving is 237 milliliters (˜8 fl. oz.). In other embodiments, when the nutritional composition is a liquid, the serving is 177 milliliters to 414 milliliters (˜6 fl. oz. to ˜14 fl. oz.). In yet other embodiments, when the nutritional composition is a liquid, the serving is 207 milliliters to 266 milliliters (˜7 fl. oz. to ˜9 fl. oz.). Various calorie contents may be associated with each serving of the nutritional compositions according to the first, second and third embodiments disclosed herein, typically from 25 to 500 Kcal, including 50 to 400 Kcal; 100 to 350 Kcal or 150 to 350 Kcal per serving. Alternatively, a serving may be construed as any amount which is intended to be consumed in one sitting or within one hour or less.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus, and illustrative examples shown and described. Accordingly, departures may be made from such details without departing from the spirit or scope of the applicant's general inventive concept.

1. A shelf stable nutritional composition comprising:
protein comprising 10% to 100% bovine beta-casein, the bovine beta-casein comprising 50% to 100% genetic variant A2; and
a lipophilic nutrient selected from the group comprising vitamin A, vitamin D, and vitamin E;
wherein the molar ratio of the A2 bovine beta-casein to the lipophilic nutrient is 10:1 to 10,000:1.

2. The nutritional composition of claim 1, further comprising a monoglyceride and diglyceride oil.

3. The nutritional composition of claim 1, wherein the nutritional composition is a liquid.

4. The nutritional composition of any of claim 1, wherein the bovine beta-casein is provided by at least one of: whole milk, nonfat dry milk, milk protein concentrate, total milk protein, milk protein isolate, acid casein, calcium caseinate, sodium caseinate, magnesium caseinate, purified beta-casein, and combinations thereof.

5. The nutritional composition of claim 4, wherein the bovine beta-casein is sourced from cattle selected from Bos taurus and Bos indicus.

6. The nutritional composition of any of claim 1, wherein the lipophilic nutrient is selected from the group further including lutein, lycopene, beta-carotene, zeaxanthin, alpha-cryptoxanthin, beta-cryptoxanthin, retinol, gangliosides, phosphoinositide, lipoprotein, phospholipid, glycolipid, glycophospholipid, vitamin K, vitamin E acetate, vitamin A palmitate, and combinations thereof.

7. The nutritional composition of claim 2, further comprising carbohydrate present in an amount of about 10 to about 300 grams per liter of the nutritional composition.

8. The nutritional composition of claim 2, wherein the fat is present in an amount of 5 to 100 grams per liter of the nutritional composition.

9. The nutritional composition of claim 2, wherein the protein is present in an amount of 10 to 100 grams per liter of the nutritional composition.

10. The nutritional composition of claim 2, wherein the composition comprises 5 micrograms to 250 milligrams per liter of lipophilic nutrient.

11. (canceled)

12. A liquid nutritional composition with improved lipophilic nutrient stability, the nutritional composition comprising:
carbohydrate;
protein comprising 10% to 100% bovine beta-casein, wherein the bovine beta-casein is 50% to 100% genetic variant A2;
fat; and
a premix comprising monoglyceride and diglyceride oil, and a lipophilic nutrient;
wherein the nutritional composition is formed by adding the premix to an aqueous solution to form an activated premix, and adding the activated premix to the nutritional composition.

13. The liquid nutritional composition of claim 12, wherein the premix is heated to a temperature of 60° C. to 240° C. for 10 min, to form the activated premix.

14. The liquid nutritional composition of claim 12, wherein the bovine beta-casein is provided by at least one of: whole milk, nonfat dry milk, milk protein concentrate, total milk protein, milk protein isolate, acid casein, calcium caseinate, sodium caseinate, magnesium caseinate, purified beta-casein, and combinations thereof.

15. The liquid nutritional composition of claim 14, wherein the bovine beta-casein is sourced from cattle selected from Bos taurus and Bos indicus.

16. The liquid nutritional composition of claim 12, wherein the lipophilic nutrient is selected from a carotenoid, a lipid soluble vitamin, an oil, a lipophilic antioxidant, and combinations thereof.

17. The liquid nutritional composition of claim 12, wherein the lipophilic nutrient is selected from vitamin A, vitamin D, vitamin E, vitamin K, lutein, lycopene, beta-carotene zeaxanthin, alpha-cryptoxanthin, beta-cryptoxanthin, retinol, gangliosides, phosphoinositide, lipoprotein, phospholipid, glycolipid, glycophospholipid, vitamin E acetate, vitamin A palmitate, and combinations thereof.

18. The liquid nutritional composition of claim 12, wherein the lipophilic nutrient is selected from vitamin A, vitamin D, and vitamin E.

19. A method for preparing a nutritional composition comprising a lipophilic nutrient having improved bioavailability, the method comprising:
providing a premix comprising monoglycerides, diglycerides, and a lipophilic nutrient;
adding the premix to an aqueous solution to form an activated premix; and
adding the activated premix to the nutritional composition;
wherein the nutritional composition comprises bovine beta-casein in an amount of 10% to 100% by weight of the total protein in the composition, the bovine beta-casein comprising 50% to 100% genetic variant A2.

20. The method of claim 19, wherein the molar ratio of A2 bovine beta-casein to lipophilic nutrient is 10:1 to 10000:1.

21. The method of claim 19, wherein the lipophilic nutrient is selected from a carotenoid, a lipid soluble vitamin, an oil, a lipophilic antioxidant, and combinations thereof.

22. The method of claim 19, wherein the lipophilic nutrient is selected from vitamin A, vitamin D, vitamin E, vitamin K, lutein, lycopene, beta-carotene, zeaxanthin, alpha-cryptoxanthin, beta-cryptoxanthin, retinol, gangliosides, phosphoinositide, lipoprotein, phospholipid, glycolipid, glycophospholipid, vitamin E acetate, vitamin A palmitate, and combinations thereof.

23. The method of claim 19, wherein the lipophilic nutrient is selected from vitamin A, vitamin D, and vitamin E.

24. (canceled)

25. (canceled)
